(19) United States
(12) Patent Application Publication
(10) Pub. No.: US 2020/0376712 A1
(43) Pub. Date: Dec. 3, 2020

(54) AUTOMATIC CONTINUOUS WEIGHING/RAW MATERIAL SUPPLY SYSTEM OF FLOORING TILE MANUFACTURING APPARATUS

(71) Applicant: Jung Soo SEO, Seoul (KR)

(72) Inventor: Jung Soo SEO, Seoul (KR)

(21) Appl. No.: 16/504,428

(22) Filed: Jul. 8, 2019

(30) Foreign Application Priority Data
May 27, 2019 (KR) 10-2019-0061657

(51) Int. Cl. B29B 7/24; B29B 7/12; B29B 17/00; B01F 15/02; B01F 15/00

(52) U.S. Cl. CPC B29B 7/244; B29B 7/125; B29B 17/0005; B29K 2027/06; B01F 15/0235; B01F 15/00194; B01F 15/0251

(57) ABSTRACT

Provided is an automatic continuous weighing/raw material supply system of a flooring tile manufacturing apparatus, and more particularly to an automatic continuous weighing/raw material supply system of a flooring tile manufacturing apparatus, which can stably supply a raw material to the flooring tile manufacturing apparatus.

### BACKGROUND OF THE INVENTION

### 1. Field of the Invention

The present invention relates to an automatic continuous weighing/raw material supply system of a flooring tile manufacturing apparatus, and more particularly to an automatic continuous weighing/raw material supply system of a flooring tile manufacturing apparatus, which can stably supply a raw material to the flooring tile manufacturing apparatus.

### 2. Description of the Prior Art

In general, flooring such as floor paper or tiles is constructed on a floor of a building, and the main material of the flooring such as floor paper or tiles is vinyl chloride that is light, flexible, and excellent in a cushioning property and a noise absorbing property.

The flooring, of which the main material is vinyl chloride, generally includes a substrate layer, of which the main material is a PVC resin, a printing layer formed at an upper end of the substrate layer, and a transparent film layer formed at an upper end of the printing layer. Then, if necessary, a coating layer for improving an anti-wear property and an anti-scratch property may be further formed at an upper end of the transparent film layer.

The substrate layer includes a PVC resin, which is a main material thereof, a filler, and a plasticizer, and the transparent film layer is manufactured only of a PVC resin without using a filler. The flooring having the above contion is used alone in a process of finishing the floor, or is used after being attached with various types of adherents or adhesives.

However, the flooring having the above structure may severely deteriorate bending stability due to a difference between are coefficients of contraction between the transparent film layer and the substrate layer, which are physical properties, causing a coming-out phenomenon during or after a construction process to make a seamed part unsmooth or causing deformation or distortion due to heat or moisture.

In order to supplement the problems, a balance layer is formed at a lower end of the PVC substrate layer to manufacture flooring. FIG. 1 is a cross-sectional view of conventional flooring having improved bending stability.

As illustrated in FIG. 1, the conventional flooring having an improved bending stability includes a substrate layer 10, a main material of which is a PVC resin, a print layer 20 and a transparent film layer 30 sequentially joined to an upper side of the substrate layer 10, and a balance layer 40 joined to a lower end of the substrate layer 10.

Further, the substrate layer 10 includes an upper PVC layer 11, a lower PVC layer 13, and a nonwoven fabric layer embedded between the upper PVC layer 11 and the lower PVC layer 13.

In order to manufacture the above-structured conventional flooring having an improved bending stability, first, the print layer 20 and the transparent film layer 30 have to be prepared and the substrate layer 10 and the balance layer 40 have to be separately manufactured.

Further, in order to manufacture the substrate layer 10, a nonwoven fabric has to be inserted between the upper PVC layer 11 and the lower PVC layer 13 and then be heat-pressed after the upper PVC layer 11 and the lower PVC layer 13 are separately formed. Then, a process of cutting the upper PVC layer 11 and the lower PVC layer 13 into specific sizes is necessary in order to join the upper PVC layer 11 and the lower PVC layer 13 after the upper PVC layer 11 and the lower PVC layer 13 are formed at a high temperature, and a process of cooling and aging the upper PVC layer 11 and the lower PVC layer 13 is necessary in order to prevent deformation and distortion of the upper PVC layer 11 and the lower PVC layer 13. After the cooling and aging processes, the upper PVC layer 11 and the lower PVC layer 13 are reheated and heat-pressed to manufacture the substrate layer 10.

In this way, in order to join the substrate layer 10 and the balance layer 40 even after the substrate layer 10 is manufactured, a process of reheating and heat-pressing the substrate layer 10 and the balance layer 40 has to be performed via a process of cooling and aging the substrate layer 10.

As described above, according to the conventional flooring having an improved bending stability, because the upper PVC layer 11, the lower PVC layer 13, and the balance layer 40 have to be separately formed and heating, cooling, aging, and reheating have to be repeatedly performed in the forming and joining process, consumptions of energy, such as fuels and electricity, due to the reheating after the cooling is large, labor costs increase, and productivity decrease.

Further, in order to manufacture the flooring, several steps, for example, for supply and heating of a raw material, forming respective stairs, cooling and aging, reheating, and joining, have to be performed. Then, if a problem occurs in a specific part of the manufacturing process, the entire process and system are stopped, and then, much time and high costs are required to operate the manufacturing apparatus again, which causes high loss. Accordingly, the entire manufacturing system has to be continuously performed while not being stopped.

### PRIOR TECHNICAL DOCUMENTS

### Patent Documents

(Patent Document 1) Korean Patent No. 10-0510836 (Aug. 30, 2005)

### SUMMARY OF THE INVENTION

The present invention provides an automatic continuous weighing/raw material supply system of a flooring tile manufacturing apparatus capable of continuously introducing a raw material to produce products for mass production, which can stably supply a raw material to the flooring tile manufacturing apparatus even though a problem occurs in a part of the apparatus.

In accordance with an aspect of the present invention, there is provided an automatic continuous weighing/raw material supply system of a flooring tile manufacturing apparatus capable of continuously producing finished products from introduction of a raw material in a straight process line without a curve, the raw material supply system including: a mixing unit configured to mix different kinds of materials; a first mixing tank configured to receive a mixture material from the mixing unit; a first weighing hopper configured to receive the mixture material from the first mixing tank; a second mixing tank configured to receive a mixture material from the mixing unit; a second weighing hopper configured to receive the mixture material from the second mixing tank; a plurality of supply hoppers configured to receive the mixture material from the first weighing hopper or the second weighing hopper; a first banbury mixer configured to receive the mixture material from the plurality of supply hoppers; and a second banbury mixer configured to receive the mixture material from the plurality of supply hoppers, wherein the first banbury mixer receives the mixture material from the plurality of supply hoppers according to priorities designated for the plurality of supply hoppers, and wherein the second banbury mixer receives the mixture material from the plurality of supply hoppers according to priorities designated for the plurality of supply hoppers.

The supply hopper may include a first supply hopper, a second supply hopper, a third supply hopper, and a fourth supply hopper, the first supply hopper and the second supply hopper may selectively receive the mixture material from the first weighing hopper, the third supply hopper and the fourth supply hopper may selectively receive the mixture material from the second weighing hopper, and the first supply hopper, the second supply hopper, the third supply hopper, and the fourth supply hopper may selectively supply the mixture material to the first banbury mixer and the second banbury mixer according to the priorities.

Each of the first mixing tank, the second mixing tank, the first weighing hopper, the second weighing hopper, and the supply hopper may include a weight sensor configured to measure the weight of the supplied mixture material, and the mixture material may be supplied or interrupted according to a preset reference weight of the mixture material.

The mixing unit may include: a hard coal tank configured to receive hard coals from a first main storage tank; a PVC tank configured to receive polyvinyl chloride from a second main storage tank; a recycle tank configured to receive mixture material pieces generated after the flooring tile is manufactured, and grind the mixture material pieces; and a screw conveyor configured to receive the hard coals, the polyvinyl chloride, and the ground mixture materials from the hard coal tank, the PVC tank, and the recycle tank, mix the hard coals, the polyvinyl chloride, and the ground mixture materials, and feed the hard coals, the polyvinyl chloride, and the ground mixture materials, which have been mixed, and the screw conveyor may selectively supply the mixture material to any one of the first mixing tank and the second mixing tank.

The automatic continuous weighing/raw material supply system of a flooring tile manufacturing apparatus according to the present invention can continuously introduce a raw material to produce products for mass production, and can stably supply a raw material to the flooring tile manufacturing apparatus while the entire system of the flooring tile manufacturing apparatus is not stopped even though a problem occurs in a part of the apparatus, thereby allowing continuous and stable manufacturing of flooring tiles.

### BRIEF DESCRIPTION OF THE DRAWINGS

The above and other objects, features, and advantages of the present invention will be more apparent from the following detailed description taken in conjunction with the accompanying drawings, in which:

FIG. 1 is a sectional view of conventional flooring having an improved bending stability;

FIG. 2 is a view schematically illustrating a movement path of a material for manufacturing a flooring tile and a raw material of the tile according to an embodiment of the present invention;

FIG. 3 is a view schematically illustrating configurations of a lower sheet forming unit and a middle sheet forming unit according to the embodiment of the present invention;

FIG. 4 is a view schematically illustrating a lower sheet storage unit according to the embodiment of the present invention;

FIG. 5 is a view schematically illustrating a lower sheet forming unit according to the embodiment of the present invention;

FIG. 6 is a view illustrating a cooling unit according to the embodiment of the present invention; and

FIGS. 7 and 8 are views illustrating an automatic continuous weighing/raw material supply system of a flooring tile manufacturing apparatus according to an embodiment of the present invention.

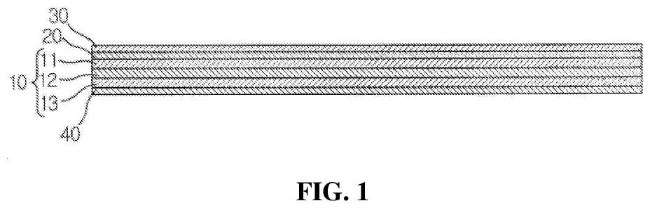

### DETAILED DESCRIPTION OF THE EXEMPLARY EMBODIMENTS

First, in the present invention, a flooring tile of the present invention has a structure in which a lower sheet 1, a middle sheet 2, a print sheet having a pattern or a color, a transparent sheet 4, and an ultraviolet (UV) coating layer (not illustrated) are sequentially stacked. The thicknesses of the print sheet, the transparent sheet, and the UV coating layer are very thin and the contraction rates thereof are high as compared with the middle sheet. Accordingly, while the print sheet, the transparent sheet, and the UV coating layer are joined to the middle sheet, bending or distortion of the flooring tile may be caused by the difference between the contraction rates. In order to solve the problems, the lower sheet is attached to a surface of the middle sheet, which is opposite to the surface on which the print sheet, the transparent sheet, and the UV coating layer are attached.

Meanwhile, conventionally, a flooring tile having a total thickness of 3 T are manufactured by using a total of three sheets including one lower sheet (thickness of 0.9 T) and two middle sheets (thickness of 0.9 T), the three sheets are individually produced at a temperature of 180 degrees and are cooled to an atmospheric temperature of 20 degrees, and the cooled lower sheet and middle sheets are wound in a roll state and then are preserved. Further, in order to combine the lower sheet and the middle sheets closely, they have to be reheated to a temperature of 180 degrees. For this reason, the heat loss, the electricity costs, labor costs, and the investment costs and installation space for mass-consumed inline machines are excessive and consumptions are high in proportion of the production rate of the products.

Further, productivity decreases as heat slowly penetrates into the lower sheet or the middle sheets when the lower sheet or the middle sheets having a thickness of more than 0.9 T are heated and continuous production becomes impossible as the production is ceased in spite that the heat may rapidly penetrates into the interiors of the lower sheet or the middle sheets due to the relatively small thicknesses in the case of the lower sheet or the middle sheets of a thickness of 0.9 T or less.

In particular, because one lower sheet (thickness of 0.9 T) and four middle sheets (thickness of 0.9 T) have to be produced to produce a product having a thickness of 5 T and a total of 7 sheets including one transparent sheet (thickness of 0.3 T) and one print sheet (thickness of 0.08 T) have to be combined, the manufacturing apparatus becomes complex and the volume and installation space of the manufacturing apparatus rapidly increase. Because when one middle sheet (thickness of 3.6 T) is manufactured to decrease the volume and installation space of the manufacturing apparatus, a time period for heating the middle sheet to a temperature of 180 degrees, at which the middle sheet may be combined at an atmospheric temperature rapidly increases, there is a limit in increasing the productivity of the product.

Hereinafter, a flooring tile manufacturing apparatus will be described in detail with reference to the accompanying drawings.

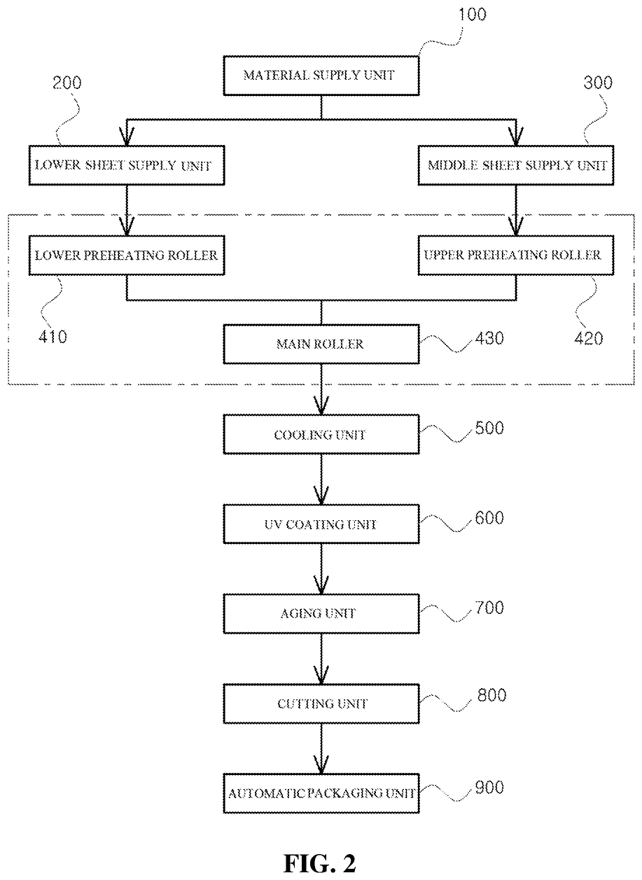

As illustrated in FIGS. 2 to 6, the flooring tile manufacturing apparatus according to the embodiment of the present invention includes a raw material supply unit 100, a lower sheet supply unit 200, a middle sheet supply unit 300, a combination sheet unit (a lower preheating roller 410, an upper preheating roller 420, a main roller 430, a heater 440, a first pressing roller 450, a first sheet supply unit 460, a second sheet supply unit 470, and a second pressing roller 480), a cooling unit 500, a UV coating unit 600, an aging unit 700, a cutting unit 800, and an automatic packaging unit 900. The components of the flooring tile manufacturing apparatus according to the embodiment of the present invention are disposed in a straight line such that the flooring tiles may be mass-produced while the material and the raw material of the tiles may be supplied without being ceased.

The raw material supply unit 100 stores the materials for forming a lower sheet 1 and a middle sheet 2, and supplies materials having different contents of fillers to the lower supply unit 200 and the middle supply unit 300.

In detail, the material supply unit 100 may be divided into a first main storage tank 110 and a second main storage tank 120. Hard coals are stored in the first main storage tank 110 as a filler, and polyvinyl chloride (PVC) is stored in the second main storage tank 120.

Two material supply lines that are independently operated are formed in the first main storage tank 110. Any one of the two material supply lines supplies the material to the lower sheet supply unit 200, and the other of the two material supply lines supplies the material to the middle sheet supply unit 300.

Two material supply lines that are independently operated are formed in the second main storage tank 110 as in the first main storage tank 110. Any one of the two material supply lines supplies the material to the lower sheet supply unit 200, and the other of the two material supply lines supplies the material to the middle sheet supply unit 300.

The materials for forming the lower sheet 1 and the middle sheet 2 include polyvinyl chloride, a filler and a plasticizer for making the formed product flexible. The filler improves physical properties such as strength and hardness, and employs calcium carbide (CaCo₃) in this embodiment. The filler is also called hard coals or coal stone, and various different fillers may be used in addition to calcium carbide.

Meanwhile, calcium carbide included in the material, which is supplied to the lower sheet supply unit 200, for 100 parts by weight of the material is 50 parts by weight or less, and calcium carbide included in the material, which is supplied to the middle sheet supply unit 300, for 100 parts by weight of the material is 70 parts by weight or more.

As the content ratio of calcium carbide, that is, the filler increases, contraction rate decreases, preventing deformation of the material, which is advantageous for maintaining the shape of the material, but if the percentage of the filler is excessively large, there is a possibility of cracking or breaking, which increases costs. Since there is a need to decrease the contraction rate and deformation rate of the middle sheet 2, the filler of 70 parts by weight or more is included for the material of the middle sheet 2 of 100 parts by weight. Accordingly, in order to satisfy balance of the contraction and deformation by the print sheet 3 and the transparent sheet 4 and prevent cracking or breaking of the middle sheet 2 by adding flexibility, the lower sheet 1 including the filler of 50 part by weight or less for the material of 100 part by weight is coupled to the middle sheet 2.

The preferable composition ratio of the lower sheet 1 is as Table 1.

TABLE 1

| | Polyvinyl | | |
|---|---|---|---|
| Composition | chloride | Filler | Plasticizer |
| Ratio | 36.3 wt % | 47.3 wt % | 16.4 wt % |

The preferable composition ratio of the middle sheet 2 is as Table 2.

TABLE 2

| | Polyvinyl | | |
|---|---|---|---|
| Composition | chloride | Filler | Plasticizer |
| Ratio | 17 wt % | 71.9 wt % | 11.1 wt % |

The contraction rate of the formed product varies according to the content of the filler (calcium carbide), and accordingly, a difference between the contraction rates of the lower sheet 1 and the middle sheet 2 occurs.

The present invention minimizes deformation and distortion of the flooring tile based on the balance of the contraction rate by the print sheet 3, the transparent sheet 4, and the UV coating layer joined to one surface of the middle sheet 2 and the contraction rate by the lower sheet 1 joined to the other surface of the middle sheet 2. The lower sheet 1 is also generally called a balance sheet.

The lower sheet supply unit 200 supplies a mixture material for forming the lower sheet 1. The lower sheet supply unit 200 includes a mixing unit 210, a lower sheet forming unit 210, and a lower sheet storage unit 220.

The mixing unit 201 receives hard coals and polyvinyl chloride (PVC) from the first main storage tank 110 and the second main storage tank 120 and mixes the hard coals and polyvinyl chloride. Further, the plasticizer and the pigment may be mixed in a process of delivering the mixture material from the mixing unit 201 to the lower sheet forming unit 210.

In detail, the mixing unit 201 includes a hard coal tank 2011, a PVC tank 2012, a pigment tank 2013, a plasticizer tank 2014, a recycle tank 2015, and a screw conveyor 2016. The hard coal tank 2011 receives hard coals from the first main storage tank 110, and the PVC tank receives polyvinyl chloride from the second main storage tank 120. The pigment tank 2013 stores pigment, and the pigment is mixed with the mixture material of the hard coals and polyvinyl chloride. The plasticizer tank 2014 stores plasticizer and the plasticizer is mixed with the mixture material of the hard coals and polyvinyl chloride. The recycle tank 2015 receives side-products (residues) left after the flooring tile is manufactured and grinds the side-products, and the ground side-products are mixed with the hard coals and polyvinyl chloride. The screw conveyor 2016 receives the hard coals, polyvinyl chloride, and the ground side-products from the hard coal tank 2011, the PVC tank 2012, and the recycle tank 2015, respectively, and mixes them while feeding them in any one direction. The screw conveyor 2016 has a U-shaped cross-section, and extends long to be located under the hard coal tank 2011, the PVC tank 2012, and the recycle tank 2015.

In this way, the mixture material mixed and fed by the screw conveyor 2016 is supplied to the first mixing tank 211a or the second mixing tank 211b. The pigment and the plasticizer may be delivered to the screw conveyor 2016 and be mixed with the hard coals, polyvinyl chloride, and the like, and may be introduced into the supply line when the mixture material of the hard coals and polyvinyl chloride is supplied to the first mixing tank 211a or the second mixing tank 211b.

The lower sheet forming unit 210 receives the mixture material from the mixing unit 201 and forms the lower sheet 1. The lower sheet storage unit 220 stores the formed lower sheet 1.

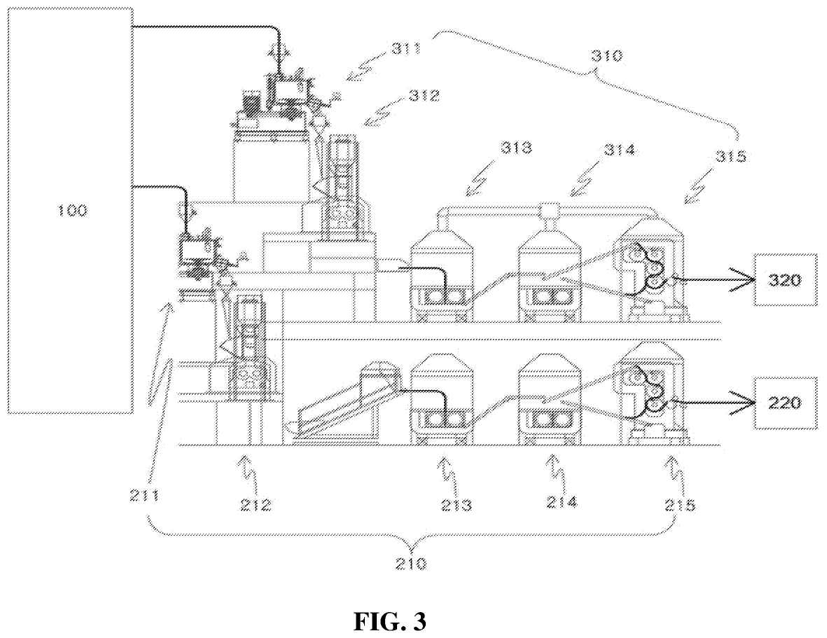

As illustrated in FIG. 3, the lower sheet forming unit 210 includes a lower mixing tank 211, a lower banbury mixer 212, first and second lower mixing rollers 214, and a lower calendar roller 215, and the mixture material passes in a sequence. The lower mixing tank 211 receives the material for forming the lower sheet 1 from the mixing unit 201 and mixes the material. The lower banbury mixer 212 makes a form of dough from the materials mixed by the lower mixing tank 211 through heat (170 to 180 degrees), pressure, and friction. In the present embodiment, in order to mass-produce the thick lower sheet 1, the lower mixing tank 211 includes a first mixing tank 211a and a second mixing tank 211b, and the lower banbury mixer 212 includes a first banbury mixer 212a and a second banbury mixer 212b.

A plurality of weighing hoppers and a plurality of supply hoppers are provided between the lower mixing tank 211 and the lower banbury mixer 212 to deliver the mixture material.

The weighing hoppers include a first weighing hopper 202a and a second weighing hopper 202b. The first weighing hopper 202 a receives the mixture material from the first mixing tank 211a, and the second weighing hopper 202b receives the mixture material from the second mixing tank 211b.

The supply hoppers include a first supply hopper 203a, a second supply hopper 203b, a third supply hopper 203c, and a fourth supply hopper 203d. The first supply hopper 203a and the second supply hopper 203b receive the mixture material from the first weighing hopper 202a. The third supply hopper 203c and the fourth supply hopper 203d receive the mixture material from the second weighing hopper 202b. Further, the first to fourth supply hoppers may deliver the mixture material to the first banbury mixer 212a and the second banbury mixer 212b, respectively.

Each of the mixing tank, the weighing hoppers, the supply hoppers, and the lower banbury mixer, which have been described above, includes a weight sensor (not illustrated) configured to measure the weight of the mixture material accommodated in an accommodation tank thereof, and a sensor (not illustrated) configured to detect the height of the mixture material accommodated in the accommodation tank thereof to determine the supply timing and the interruption timing of the mixture material.

The first lower mixing roller 213 includes two heating rollers, and compresses and kneads the material by passing the material kneaded by the lower banbury mixer 212 between the two heating rollers (150 to 170 degrees). The first lower mixing roller 213 selectively receives the kneaded mixture material from the lower banbury mixer of any one of the first banbury mixer 212a and the second banbury mixer 212b.

The second lower mixing roller 214 compresses and kneads the material that passed through the first lower mixing roller 213 to a temperature of 160 to 180 degrees again, and supplies the kneaded material to the lower calender roller 215. The lower calender roller 215 makes a form of a plate having a specific thickness and a specific width from the mixed and kneaded material by using the aperture between the heating rollers and delivers the plate to the lower sheet storage unit 220. The lower calender roller 215 includes a plurality of heating rollers, and a roller, through which the material passes first, of a plurality of rollers of the lower calender roller 215 heats the material to 140 to 160 degrees and then the heating rollers heats the material to 160 to 180 degrees. In this way, the lower sheet 1 that passed through the lower calender roller 215 is delivered to the lower sheet storage unit 220 by a cooling mesh conveyor of 120 to 140 degrees.

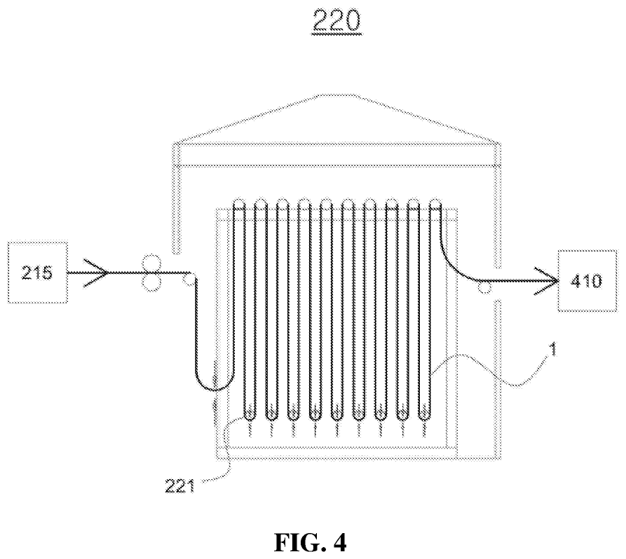

As illustrated in FIG. 4, the lower sheet storage unit 220 includes a plurality of lower sheet support rollers 221, a sensor (not illustrated), and a control unit (not illustrated), and each of the plurality of lower sheet support rollers 221 adjusts the amount of the lower sheets 1 accommodated in the lower sheet storage unit 220 by elevating according to a difference between the speed at which the lower sheets 1 are introduced from the lower sheet forming unit 210 to the lower sheet storage unit 220, and the speed at which the lower sheets 1 is discharged from the lower sheet storage unit 220. In detail, if the discharge speed of the lower sheets 1 is higher than the introduction speed of the lower sheets 1, the lower sheets 1 stored in the lower sheet storage unit 220 are discharged earlier while the plurality of lower sheet support rollers 221 are lifted sequentially, and if the discharge speed of the lower sheets 1 is lower than the introduction speed of the lower sheets 1, the introduced lower sheets 1 are stored in the lower sheet storage unit 220 while the plurality of lower sheet support rollers 221 are lowered sequentially. Further, the lower sheets 1 stored in the lower sheet storage unit 220 are maintained at a temperature of 110 to 130 degrees.

Meanwhile, if the introduction speed of the lower sheets 1 is the same as the discharge speed of the lower sheets 1, a total amount of the lower sheets 1 stored in the lower sheet storage unit 220 is not changed and the lower sheet support rollers 221 do not move.

The lower sheets 1 are stored in the interior of the above-mentioned lower sheet storage unit 220, and an upper cover part of the lower sheet storage unit 220 may be lifted such that the interior of the lower sheet storage unit 220 is opened.

The middle sheet supply unit 300 receives the material for forming the middle sheets 2 from the material supply unit 100 and forms and supplies the middle sheets 2. The middle sheet supply unit 300 includes a middle sheet forming unit 310 for forming the middle sheets 2 and a middle sheet storage unit 320 for storing the middle sheets 2. The middle sheet forming unit 310 and the middle sheet storage unit 320 are located above the lower sheet forming unit 210 and the lower sheet storage unit 220, and the structures and functions thereof are the same as those of the lower sheet forming unit 210 and the lower sheet storage unit 220, and thus a detailed description thereof will be omitted (see FIGS. 3 and 4).

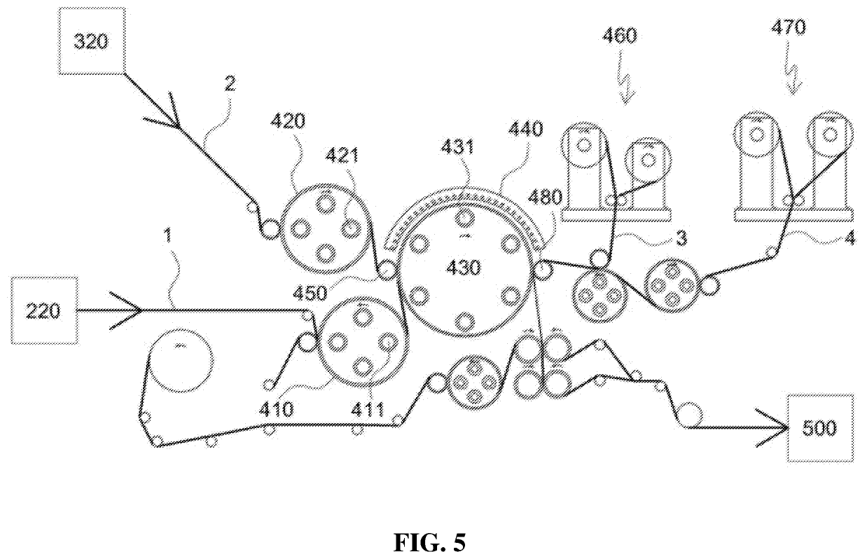

As illustrated in FIG. 5, the lower sheet forming part includes a lower preheating roller 410, an upper preheating roller 420, a main roller 430, a heater 440, a first pressing roller 450, a first sheet supply unit 460, a second sheet supply unit 470, and a second pressing roller 480.

The lower preheating roller 410 receives the lower sheet 1 from the lower sheet supply unit 200 and delivers the lower sheet 1 to the main roller 430 after heating the lower sheet 1 to 170 to 190 degrees. A plurality of heating means 411 are installed in the interior of the lower preheating roller 410 along a circumferential surface of the lower preheating roller 410 to heat the lower sheet 1 passing by the lower preheating roller 410.

The upper preheating roller 420 receives the middle sheet 2 from the middle sheet supply unit 300 and delivers the middle sheet 1 to the main roller 430 after heating the middle sheet 2 to 170 to 190 degrees. A plurality of heating means 421 are installed in the interior of the upper preheating roller 420 along a circumferential surface of the upper preheating roller 420 to heat the middle sheet 2 passing by the upper preheating roller 420.

As mentioned above, because the lower sheet 1 and the middle sheet 1 are delivered to the lower sheet preheating roller 410 and the upper preheating roller 420 while being maintained at a high temperature after being heated when the materials are mixed and formed through the lower sheet supply unit 200 and the middle sheet supply unit 300, a temperature deviation from an initial temperature to a target temperature that is necessary for joining the lower sheet 1 and the middle sheet 2 is not large when the lower sheet 1 and the middle sheet 2 is heated to the target temperature by the lower preheating roller 410 and the upper preheating roller 420. Accordingly, consumption of energy for heating may be reduced. Further, although the heating time may be long until the interior of the middle sheet 2 is heated to a target temperature when the thickness of the middle sheet 2 is as thick as 1 T (1 mm) or more, the middle sheet 2 is delivered while maintaining a high temperature so that the interior of the middle sheet 2 is maintained at a higher temperature than the surface of the middle sheet 2 and the middle sheet 2 may be heated to the target temperature rapidly even when the thickness of the middle sheet is large. Accordingly, the process may be rapidly performed and the products may be mass-produced even when the thickness of the middle sheet 2 is large.

The main roller 430 receives and joins the lower sheet 1 and the middle sheet 2. A plurality of heating means 431 are installed in the interior of the main roller 430 to maintain the temperatures of the lower sheet 1 and the middle sheet 2, which pass by the main roller 430, at 170 to 190 degrees.

The above-mentioned heating means 411, 421, and 431 may be heating wires passing through the rollers or heating fluids passing through the passages formed in the interiors of the rollers.

The heaters 440 are located above the main roller 430 to heat the lower sheet 1 and the middle sheet 2 moving along the main roller 430. That is, opposite surfaces of the lower sheet 1 and the middle sheet 3, which move along the main roller 430, are heated by the heater 440 of the main roller 430.

The first pressing roller 450 presses the lower sheet 1 and the middle sheet 2 towards the main roller 430 to bond the lower sheet 1 and the middle sheet 2 together.

The first sheet supply unit 460 supplies the print sheet 3 having a color or a pattern to the main roller 430. The first sheet supply unit 460 may include two rollers such that the two rollers may be alternately used according to the situation.

The second sheet supply unit 470 supplies the transparent sheet 4 to the main roller 430. The second sheet supply unit 470 also may include two rollers such that the two rollers may be alternately used according to the situation.

The second pressing roller 480 presses the print sheet 3 and the transparent sheet 4 towards the main roller 430 to bond the print sheet 3 and the transparent sheet 4 together to the surface of the middle sheet 2.

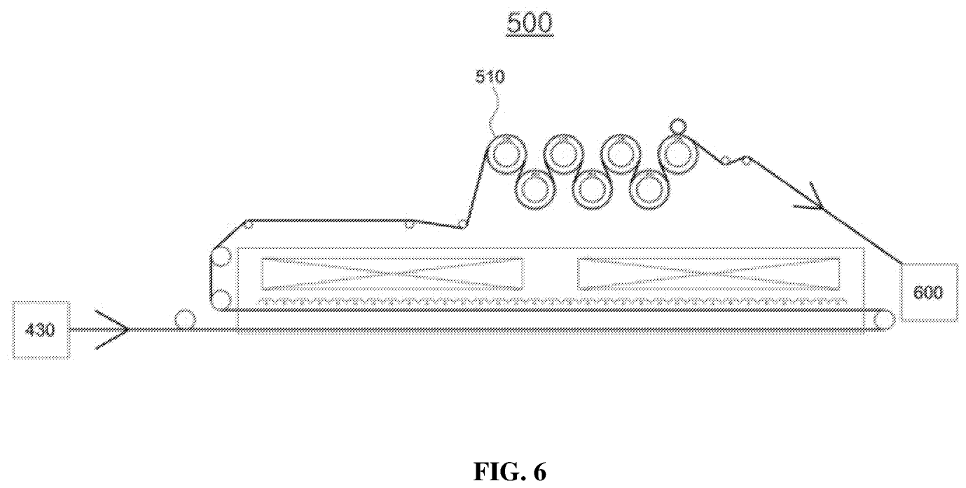

As illustrated in FIG. 6, the cooling unit 500 includes a plurality of cooling rollers 510 by which the raw material of the tile, to which the lower sheet 1, the middle sheet 2, the print sheet 3, and the transparent sheet 4 are sequentially bonded, passes. A cooling means is installed in each of the plurality of cooling rollers 510, and opposite surfaces of the raw material of the tile alternately contact the plurality of cooling rollers 510 to be cooled. The cooling means may be cooling water passing through the passages formed in the interiors of the cooling rollers 510. The raw material of the tile is cooled to 20 to 40 degrees by the cooling unit 500.

The UV coating unit 600 forms a UV coating layer on a surface of the transparent sheet 4. In detail, the UV coating unit 600 constantly fuses an ultraviolet (UV) ray to the surface of the transparent sheet 4 to UV dry the surface of the transparent sheet 4 and increase the strength of the surface of the transparent sheet 4, thereby extending the life span of the surface of the product and preventing scratching.

The aging unit 700 is classified into a hot water ager and a cold water ager. The hot water ager prevents contraction of a product by aging the raw material of the tile that passed through the UV coating unit 600 for a predetermined time when the raw material of the tile is fed while being submerged in water of 80 to 90 degrees. The hot water ager includes an electric heater 440 and a steam line. Further, the cool water ager maintains specific elastic characteristics of the product while feeding the raw material of the tile, which passed through the hot water ager, in a state in which the raw material of the tile is submerged in cold water of a predetermined temperature.

The cutting unit 800 cuts the raw material of the tile according to the size of the final product. The cutting unit 800 may adjust the work rate according to the production rate of the product by alternately using the two cutting machines. Further, recesses may be machined at four sites of the side surface of the product, which has been finished after the raw material of the tile was cut, to increase the convenience of construction and minimize contraction and expansion of the product.

The automatic packaging unit 900 automatically packages the cut products in a box after loading the products.

Accordingly, the flooring tile manufacturing apparatus may continuously perform a process of manufacturing a flooring tile through the above-mentioned components, and may improve the quality and productivity of the product.

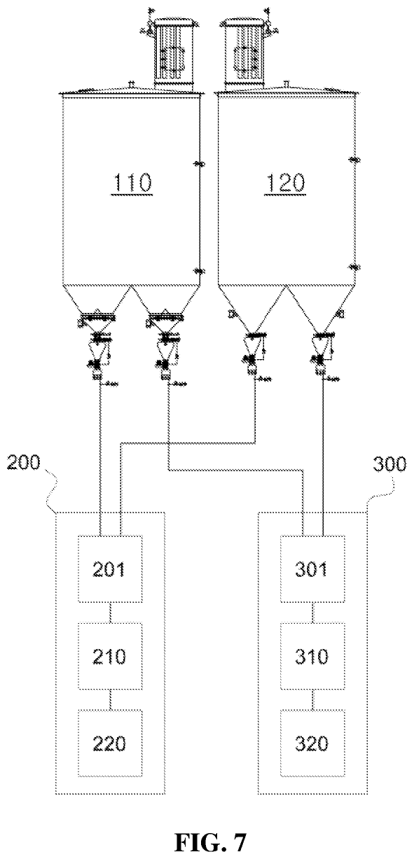

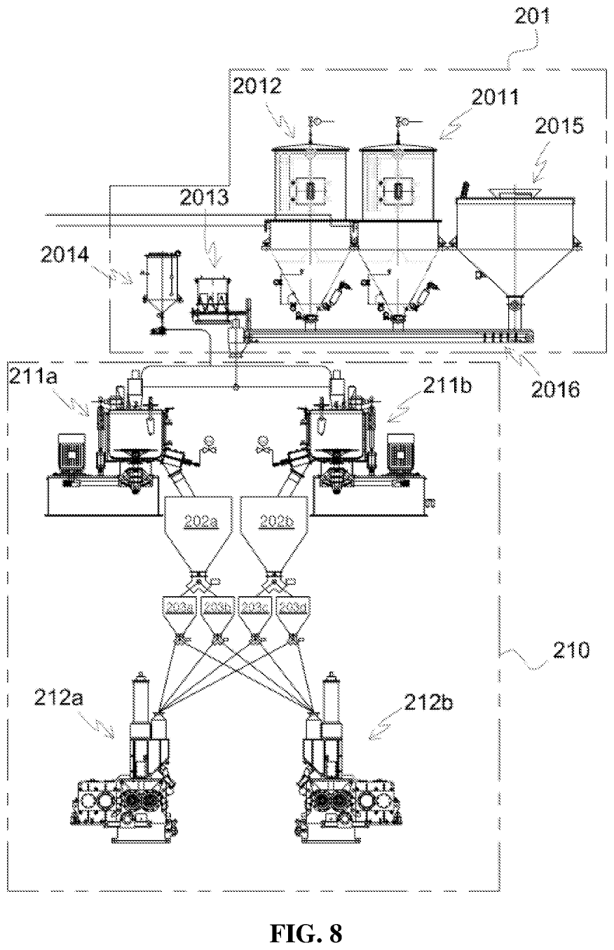

Next, the automatic continuous weighing/raw material supply system of the flooring tile manufacturing apparatus of the present invention will be described with reference to FIGS. 7 and 8.

In the present invention, the material supply unit 100 supplies the raw material to the lower sheet supply unit 200 and the middle sheet supply unit 300. Further, the lower sheet supply unit 200 sequentially delivers and supplies the mixture material to the mixing unit 201, the lower sheet forming unit 210, and the lower sheet storage unit 220. Since the delivery and supply means and methods of the middle sheet supply unit 300 also are the same as those of the lower sheet supply unit, a material supply system of the lower sheet supply unit will be described.

First, the mixing unit 201 delivers the mixture material to the first mixing tank 211a and the second mixing tank 211b. Then, the mixing unit 201 selectively supplies the mixture material to any one of the first mixing tank 211a and the second mixing tank 211b. That is, the supply of the mixture material to the second mixing tank 211b is interrupted when the mixture material is supplied to the first mixing tank 211a, and the supply of the mixture material to the first mixing tank 211a is interrupted when the mixture material is supplied to the second mixing tank 211b. Further, when the amount of the mixture material in the interior of the first mixing tank 211a or the second mixing tank 211b is smaller than a preset reference amount, the mixture material is supplied to the corresponding mixing tank. As mentioned above, the first mixing tank 211a and the second mixing tank 211b can detect the timing for the supply and interruption of the mixture material by using a sensor which may measure the weight and height of the mixture material in the interiors thereof.

The first mixing tank 211a and the second mixing tank 211b may supply about 80% of the mixture material for manufacturing the flooring tile. Accordingly, when both the first mixing tank 211a and the second mixing tank 211b are normally operated, only 50% of the mixture material is supplied. If any one of the first mixing tank 211a and the second mixing tank 211b fails and is stopped, only the remaining mixing tank is operated and supplies the mixture material. Then, since a total of 80% of the necessary mixture material may be supplied even though one mixing tank is operated alone, the entire system can be operated consistently and stably.

Further, the first mixing tank 211a supplies the mixture material to the first weighing hopper 202a, and the second mixing tank 211b supplies the mixture material to the second weighing hopper 202b. That is, the first mixing tank 211a supplies the mixture material only to the first weighing hopper 202a, and the second mixing tank 211b supplies the mixture material only to the second weighing hopper 202b. The first weighing hopper 202a and the second weighing hopper 202b also measure the amount of the mixture material accommodated in the interiors thereof and may detect the supply and interruption timings of the mixture material.

If the first weighing hopper 202a and the second weighing hopper 202b also fail and an operation of any one of the first weighing hopper 202a and the second weighing hopper 202b is stopped, the remaining weighing hopper and the mixing tank which supplies the mixture material to the corresponding weighing hopper is operated so that the mixture material may be supplied consistently and stably.

The first supply hopper 203a and the second supply hopper 203b receive the mixture material from the first weighing hopper 202a. The first weighing hopper 202a selectively supplies the mixture material to any one of the first supply hopper 203a and the second supply hopper 203b. That is, if the amount of the mixture material accommodated in the first supply hopper 203a or the second supply hopper 203b becomes smaller than the reference amount, the mixture material is supplied to the corresponding supply hopper and interrupts a fuel supply pipe connected to the other supply hopper. If both the amounts of the mixture material accommodated in the first supply hopper 203a and the second supply hopper 203b is more than the reference amount, the supply of the mixture material by the first weighing hopper 202a is stopped. Further, the first supply hopper 203a and the second supply hopper 203b may supply the mixture material to the first banbury mixer 212a and the second banbury mixer 212b, respectively.

Further, the third supply hopper 203c and the fourth supply hopper 203d receive the mixture material from the second weighing hopper 202b. The second weighing holler 202a selectively supplies the mixture material to any one of the third supply hopper 203c and the fourth supply hopper 203d. That is, if the amount of the mixture material accommodated in the third supply hopper 203c or the fourth supply hopper 203d becomes smaller than the reference amount, the mixture material is supplied to the corresponding supply hopper and interrupts a fuel supply pipe connected to the other supply hopper. If both the amounts of the mixture material accommodated in the third supply hopper 203c and the fourth supply hopper 203d are more than the reference amount, the supply of the mixture material by the second weighing hopper 202b is stopped. Further, the third supply hopper 203c and the fourth supply hopper 203d may supply the mixture material to the first banbury mixer 212a and the second banbury mixer 212b, respectively.

The first banbury mixer 212a and the second banbury mixer 212b receive the mixture material from the first to fourth supply hoppers 203a to 203d. In a general situation, it is sufficient as long as the first banbury mixer 212a and the second banbury mixer 212b receive the mixture material from two supply hoppers, but may receive the mixture material from four supply hoppers according to situations.

In detail, in order to receive the mixture material, the first banbury mixer 212a may designate priorities to the first to fourth supply hoppers 203a to 203d, and may receive the mixture material from the supply hoppers of higher priorities according to the supply priorities. That is the priorities are designated in the sequence of the first to fourth supply hoppers 203, the first banbury mixer 212a receives the mixture material from the first supply hopper 203a first. Thereafter, if the first supply hopper 203a is empty or the mixture material is being supplied from the first weighing hopper 202a to the first supply hopper 203a when the first banbury mixer 212a requires the mixture material, the first banbury mixer 212a may receive the mixture material from the second supply hopper 203b. The first banbury mixer 212a receives the mixture material from the second supply hopper 203b, and while the supplied mixture material is being used, the first supply hopper 203a receives the mixture material from the first weighing hopper 202a and is filled with the mixture material. Accordingly, the first banbury mixer 212a may receive the mixture material from the first supply hopper 203a when the mixture material is necessary again. However, if none of the first supply hopper 203a and the second supply hopper 203b is filled with the mixture material or operations of the first supply hopper 203a and the second supply hopper 203b fail, the first banbury mixer 212a receives the mixture material from an available one of the third supply hopper 203c and the fourth supply hopper 203d. If both the third supply hopper 203c and the fourth supply hopper 203d can supply the mixture material, the first banbury mixer 212a can receive the mixture material from the third supply hopper 203c according to the supply priorities.

Since the mixture material supply system of the second banbury mixer 212b also has the same as the mixture material supply system of the first banbury mixer 212a, a detailed description thereof will be omitted. Further, any one of the first banbury mixer 212a and the second banbury mixer 212b fails, only the remaining banbury mixer is operated, and the first to fourth supply hoppers supply the mixture material to the banbury mixer which may be operated according the proprieties.

The above-mentioned material supply system may be automatically implemented by the control unit of the flooring tile manufacturing apparatus.

The material supply system of the flooring tile manufacturing apparatus according to the present invention is not limited to the above-mentioned embodiments, and may be variously modified without departing from the spirit of the present invention.

What is claimed is:

1. An automatic continuous weighing/raw material supply system of a flooring tile manufacturing apparatus capable of continuously producing finished products from introduction of a raw material in a straight process line without a curve, the raw material supply system comprising:
a mixing unit configured to mix different kinds of materials;
a first mixing tank configured to receive a mixture material from the mixing unit;
a first weighing hopper configured to receive the mixture material from the first mixing tank;
a second mixing tank configured to receive a mixture material from the mixing unit;
a second weighing hopper configured to receive the mixture material from the second mixing tank;
a plurality of supply hoppers configured to receive the mixture material from the first weighing hopper or the second weighing hopper;
a first banbury mixer configured to receive the mixture material from the plurality of supply hoppers; and
a second banbury mixer configured to receive the mixture material from the plurality of supply hoppers,
wherein the first banbury mixer receives the mixture material from the plurality of supply hoppers according to priorities designated for the plurality of supply hoppers, and
wherein the second banbury mixer receives the mixture material from the plurality of supply hoppers according to priorities designated for the plurality of supply hoppers.

2. The automatic continuous weighing/raw material supply system of claim 1, wherein the supply hopper includes a first supply hopper, a second supply hopper, a third supply hopper, and a fourth supply hopper,
wherein the first supply hopper and the second supply hopper selectively receive the mixture material from the first weighing hopper,
wherein the third supply hopper and the fourth supply hopper selectively receive the mixture material from the second weighing hopper, and
wherein the first supply hopper, the second supply hopper, the third supply hopper, and the fourth supply hopper selectively supply the mixture material to the first banbury mixer and the second banbury mixer according to the priorities.

3. The automatic continuous weighing/raw material supply system of claim 1, wherein each of the first mixing tank, the second mixing tank, the first weighing hopper, the second weighing hopper, and the supply hopper includes a weight sensor configured to measure the weight of the supplied mixture material, and the mixture material is supplied or interrupted according to a preset reference weight of the mixture material.

4. The automatic continuous weighing/raw material supply system of claim 1, wherein the mixing unit includes:
a hard coal tank configured to receive hard coals from a first main storage tank;
a PVC tank configured to receive polyvinyl chloride from a second main storage tank;
a recycle tank configured to receive mixture material pieces generated after the flooring tile is manufactured, and grind the mixture material pieces; and
a screw conveyor configured to receive the hard coals, the polyvinyl chloride, and the ground mixture materials from the hard coal tank, the PVC tank, and the recycle tank, mix the hard coals, the polyvinyl chloride, and the ground mixture materials, and feed the hard coals, the polyvinyl chloride, and the ground mixture materials, which have been mixed, and
wherein the screw conveyor selectively supplies the mixture material to any one of the first mixing tank and the second mixing tank.
